(19) United States
(12) Patent Application Publication
(10) Pub. No.: US 2016/0313932 A1
(43) Pub. Date: Oct. 27, 2016

(54) DATA STORAGE SYSTEM AND DEVICE

(71) Applicant: Kabushiki Kaisha Toshiba, Minato-ku (JP)

(72) Inventors: Tomoya KODAMA, Kawasaki (JP); Atsushi MATSUMURA, Yokohama (JP)

(73) Assignee: Kabushiki Kaisha Toshiba, Minato-ku (JP)

(21) Appl. No.: 15/041,441

(22) Filed: Feb. 11, 2016

(30) Foreign Application Priority Data
Apr. 24, 2015 (JP) 2015-089602

(51) Int. Cl. G06F 3/06; G06F 12/10

(52) U.S. Cl. CPC G06F 3/0619; G06F 3/065; G06F 3/0685; G06F 12/1018; G06F 2212/401

(57) ABSTRACT

According to an embodiment, a data storage system includes a host computer performing input and output of data, and a data storage device connected to the host computer. The data storage device includes a compressor to compress data input from the host computer; a memory to store compressed data compressed by the compressor; and a first interface. When first writing data a input from the host computer, the first interface sends second writing data obtained by compressing the first writing data to the host computer. When address information corresponding to the first writing data is input from the host computer, the first interface sends read-compressed data representing the compressed data read from the memory based on the address information, to the host computer. The host computer includes a determiner to determine that the first writing data is already stored when the second writing data is identical to the read-compressed data.

### CROSS-REFERENCE TO RELATED APPLICATION(S)

This application is based upon and claims the benefit of priority from Japanese Patent Application No. 2015-089602, filed Apr. 24, 2015, the entire contents of which are incorporated herein by reference.

### FIELD

An embodiment described herein relates generally to data storage system and a data storage device.

### BACKGROUND

A data storage device such as a hard disk drive (HDD) or a solid state drive (SSD) has the fundamental function of storing data provided by a user and enabling reading of the data when necessary. In recent years, a technology has been proposed in which de-duplication and compression is performed with the aim of reducing the volume data to be recorded in a data storage device and thus equivalently increasing the storage capacity.

For example, a technology for duplication determination is known in which signature data such as the hash value of the data to be recorded (the target data for writing) is calculated in a data storage device, and the calculation result is sent to a control processor (a host) that performs control for requesting writing data in or reading data from the data storage device. Then, the control processor compares the signature data of the target data for writing as received from the data storage device with signature data of the data already recorded in the data processing device, and determines whether or not there is duplication of data.

### BRIEF DESCRIPTION OF THE DRAWINGS

FIG. 1 is a diagram illustrating an example of a hardware configuration of a data storage system according to an embodiment;

FIG. 2 is a diagram illustrating an example of the functions of the data storage system according to the embodiment;

FIG. 3 is a diagram illustrating an example of first correspondence information according to the embodiment;

FIG. 4 is a diagram for explaining the first correspondence information according to a modification example;

FIG. 5 is a diagram illustrating an example of second correspondence information according to the embodiment;

FIG. 6 is a flowchart for explaining an example of operations performed in the data storage system according to the embodiment; and

FIG. 7 is a diagram illustrating an example of the functions of the data storage system according to modification example.

### DETAILED DESCRIPTION

According to an embodiment, a data storage system includes a host that performs input and output of data; and a data storage device that is connected to the host. The data storage device includes a compressor, a memory, and a first interface. The compressor compresses data input from the host. The memory stores therein compressed data representing data compressed by the compressor. When first writing data is input from the host, the first interface sends second writing data, which is obtained by the compressor by compressing the first writing data, to the host. When address information corresponding to the first writing data is input from the host, the first interface sends read-compressed data, which represents the compressed data read from the memory based on the address information, to the host. The host includes a determiner. When the second writing data is identical to the read-compressed data, the determiner determines that the first writing data is already stored. An exemplary embodiment of a data storage system and a data storage device is described below in detail with reference to the accompanying drawings.

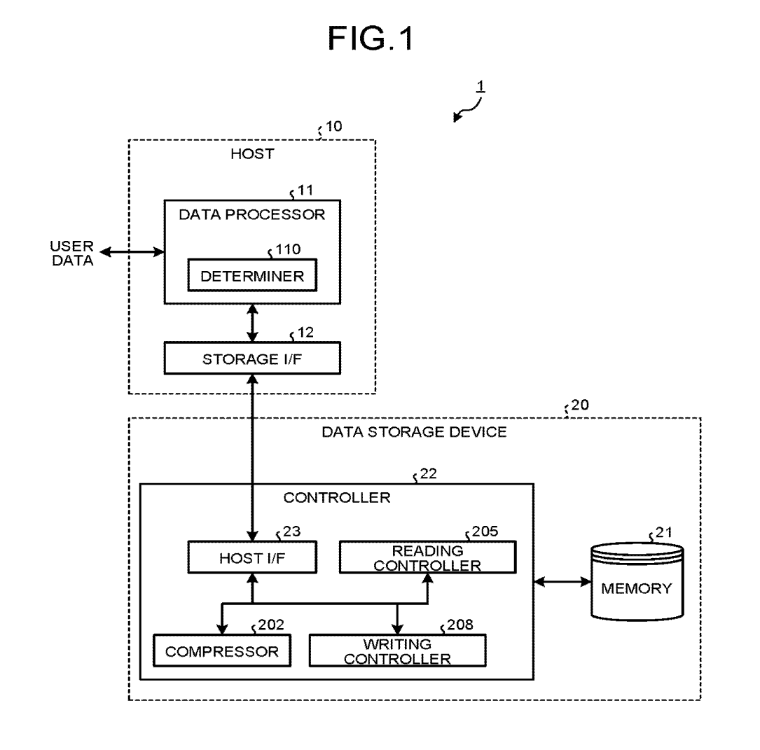

FIG. 1 is a diagram illustrating an example of a hardware configuration of a data storage system 1 according to the embodiment. The data storage system 1 according to the embodiment can provide a function of storing data that is linked to linking information such as specific addresses or specific keys specified by the user, and a function of reading data that is linked to linking information which is presented again by the user and then presenting the read data to the user. Moreover, if a request is issued for writing data that is exactly identical to the data written in the past but that is linked to different linking information; then, instead of storing the data itself, the relationship between linking information and data (as described later, the correspondence relationship between linking information and logical addresses) is stored. With that the volume of stored data can be reduced.

As illustrated in FIG. 1, the data storage system 1 at least includes a host 10 that performs inputting of data and outputting of data, and a data storage device 20 that is connected to the host. As illustrated in FIG. 1, the host 10 includes a data processor 11 and a storage I/F 12.

The data processor 11 receives input of user data that contains first writing data representing the target data for writing, contains linking information to which the first writing data is linked, and information instructing writing of the first writing data; and processes the received user data. The data processor 11 includes a determiner 110 that determines whether the first writing data, which is included in the input user data, is already stored. Moreover, the data processor 11 at least includes a central processing unit (CPU) and a memory device (a read only memory (ROM) or a random access memory (RAM)). The various functions of the data processor 11 are implemented when the CPU executes computer programs stored in the memory device. However, that is not the only possible case. Alternatively, for example, at least some of the various functions of the data processor 11 may be implemented using dedicated hardware circuitry.

The storage I/F 12 is an interface device for sending data to and receiving data from the data storage device 20.

As illustrated in FIG. 1, the data storage device 20 includes a memory 21 that stores therein data and includes a controller 22 that writes data in the memory 21 or reads data from the memory 21 in response to a request from the host 10. The memory 21 may, for example, be a non-volatile memory such as a NAND Flash. The controller 22 is configured using an integrated circuit for implementing various functions. As illustrated in FIG. 1, the controller 22 includes a host I/F 3, a compressor 202, a writing controller 208, and a reading controller 205.

The host I/F 23 is an interface device for sending data to and receiving data from the host 10. The compressor 202 compresses the data that is input from the host 10. In the following explanation, the data compressed by the compressor 202 is sometimes called “compressed data”. A writing controller 24 controls the writing of data (compressed data) in the memory 21. The reading controller 205 controls the reading of data from the memory 21.

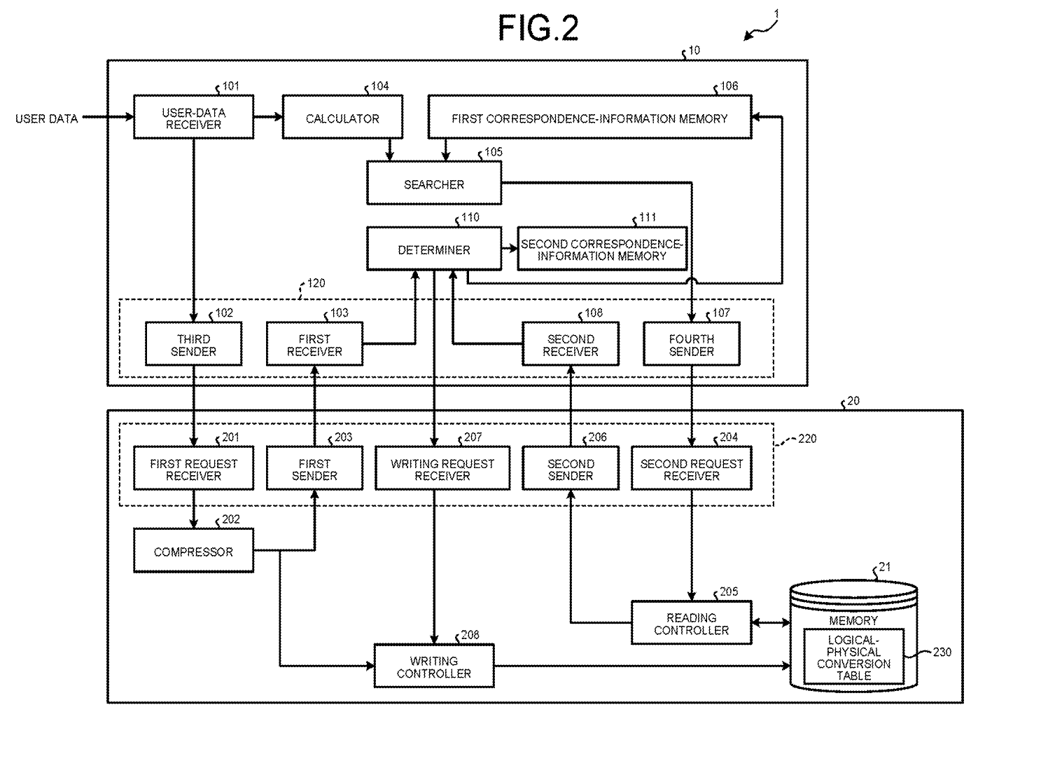

FIG. 2 is a diagram illustrating an example of the functions of the data storage system 1 according to the embodiment. For the purpose of illustration, the functions according to the embodiment are primarily illustrated. However, the functions of the host 10 and the data storage device 20 are not limited to the functions explained herein.

Given below is the explanation of the functions of the host 10. As illustrated in FIG. 2, the host 10 includes a user-data receiver 101, a second interface 120, a calculator 104, a searcher 105, a first correspondence-information memory 106, and the determiner 110.

The user-data receiver 101 receives input of user data. In this example, the function of the user-data receiver 101 is implemented by the data processor 11.

The second interface 1 includes a third sender 102, a first receiver 103, a fourth sender 107, and a second receiver 108. In this example, the function of the second interface 120 is implemented by the storage I/F 12. The third sender 102 included in the second interface 120 sends the first writing data to the data storage device 20. More particularly, the third sender 102 sends the first writing data (the target data for writing), which is included in the user data received by the user-data receiver 101, to the data storage device 20. In the embodiment, the third sender 102 sends, to the data storage device 20, a first request for compression of the first writing data included in the user data. The first request at least includes the first writing data that is included in the user data received by the user-data receiver 101.

The first receiver 103 included in the second interface 120 obtains second writing data from the data storage device 20. More particularly, the first receiver 103 obtains (receives), from the data storage device, first response data, which contains second writing data obtained by compressing the first writing data and contains first size information indicating the size of the second writing data, as a response to the first request. However, that is not the only possible case. Alternatively, for example, the configuration can be such that the second writing data and the first size information indicating the size of the second writing data are separately obtained from the data storage device 20 as a response to the first request; or to configuration can be such that only the second writing data is obtained from the data storage device 20. The functions of the fourth sender 107 and the second receiver 108 of the second interface 120 are described later.

The calculator 104 calculates the hash value of the first writing data. More particularly, when the user data is received by the user-data receiver 101, the calculator 104 calculates the hash value of the first writing data included in the received user data. In the embodiment, the calculator 104 calculates the hash value for each of a plurality of pieces of unit data obtained by dividing the first writing data. For example, the calculator 104 divides the first writing data into pieces of data having units called clusters of four kilobytes (i.e., into pieces of unit data), and calculates the hash value of each piece of unit data. The length of unit data may be fixed or may be set in a variable manner. In this example, the function of the calculator 104 is implemented by the data processor 11.

The searcher 105 refer to first correspondence information in which hash values and address information are held in a corresponding manner, and searches for the address information corresponding to the hash values calculated by the calculator 104. In this embodiment, for each of a plurality of hash values, (i.e., a plurality of hash values having a one-to-one correspondence with a plurality of pieces of unit data obtained by dividing the first writing data), the searcher 105 searches for the address information corresponding to the hash value. In this example, the address information indicates a logical address (a virtual address) enabling identification of one of a plurality of areas included in the virtual space of the host 10 used by computer programs or operating systems. In this example, the function of the searcher 105 is implemented by the data processor 11.

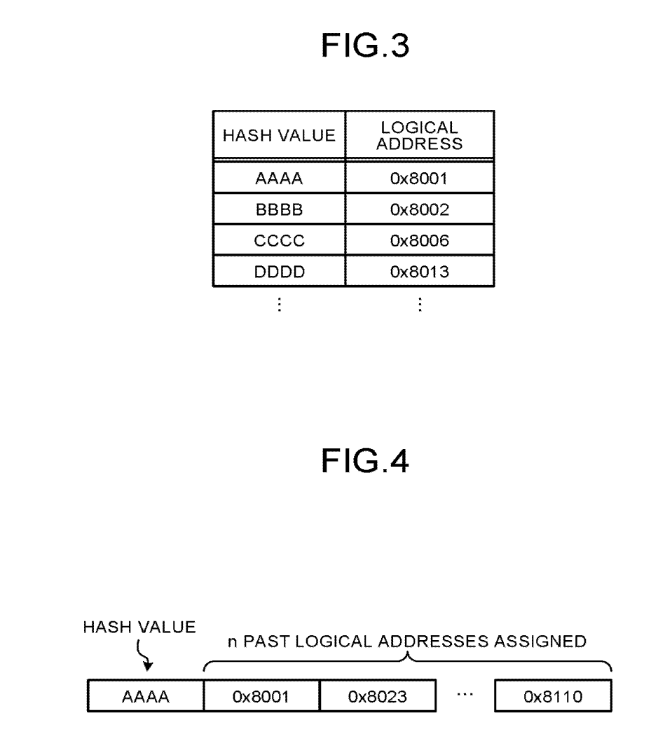

The first correspondence-information memory 106 stores therein the first correspondence information. FIG. 3 is a diagram illustrating an example of the first correspondence information. Meanwhile, for example, in the first correspondence information, for a single hash value, all previously-assigned logical addresses may be held in a corresponding manner. Regarding assigning a logical address to a hash value, the explanation is given later. For example, if, with respect to a hash value “AAAA”, n (n≧2) past logical addresses are assigned, then, as illustrated in FIG. 4, the n past logical addresses assigned to the hash value “AAAA” may be held in a corresponding manner to the hash value “AAAA”. In essence, as long as the first correspondence information indicates the correspondence relationship between hash values and address information, the first correspondence information can have an arbitrary format. In this example, the function of the first correspondence-information memory 106 is implemented by a memory device in the host.

Returning to the explanation with reference to FIG. 2, the fourth sender 107 included in the second interface 120 sends the address information, which is retrieved by the searcher 105, as the address information corresponding to the first writing data to the data storage device 20. In essence, the second interface 120 (the third sender 102 and the fourth sender 107) according to the embodiment has the function of sending the first writing data to the data storage device 20; and has the function of sending the address information, which is retrieved by the searcher 105, as the address information corresponding to the first writing data to the data storage device 20.

More specifically, the fourth sender 107 sends, to the data storage device 20, a plurality of pieces of address information retrieved by the searcher 105 and having a one-to-one correspondence with a plurality of hash values plurality of hash values having a one-to-one correspondence with a plurality of pieces of unit data obtained by dividing the first writing data that is included in the user data received by the user-data receiver 101). That is, the fourth sender 107 sends, to the data storage device 20, the address information associated with the hash values of the firs writing data, which is included in the user data received by the user-data receiver 101, as the address information corresponding to the first writing data.

In the embodiment, the fourth sender 107 sends a plurality of logical addresses, which is retrieved by the searcher 105, to the data storage device 20. More particularly, for each of a plurality of logical addresses retrieved by the searcher 105, the fourth sender 107 sends, to the fourth sender 107, a second request for reading data (compressed data based on the logical address. Each of plurality of second requests having a one-to-one correspondence with a plurality of logical addresses at least includes the corresponding logical address.

Herein, the data (compressed data) read from the memory 21 in accordance with a second request is called “read-compressed data”. The second receiver 108 included in the second interface 120 obtains the read-compressed data from the data storage device 20. In the embodiment, the second receiver 108 obtains, from the data storage device 20, second response data, which contains the read-compressed data and second size information indicating the size of the read-compressed data, as a response with respect to the second request. However, that is not the only possible case. Alternatively, for example, the read-compressed data and the second size information indicating the size of the read-compressed data may be separately obtained from the data storage device 20 as a response with respect to the second request; or only the read-compressed data may be obtained as a response with respect to the second request.

When the second writing data is identical to the read-compressed data, the determiner 110 determines that the first writing data (the first writing data serving as the source of the second writing data, that is, the first writing data included in the user data which is received by the user-data receiver 101) is already stored (i.e., the first writing data represents duplicate data). In the embodiment, for each of a plurality of pieces of read-compressed data having a one-to-one correspondence with a plurality of pieces of address information retrieved by the searcher 105, the determiner 110 determines whether or not the read-compressed data is identical to the second writing data. More specifically, for the read-compressed data included in each of a plurality of pieces of second response data obtained by the second receiver 108 (i.e., a plurality of pieces of second response data having a one-to-one correspondence with a plurality of logical addresses retrieved by the searcher 105 (having a one-to-one correspondence with a plurality of second requests)), the determiner 110 determines whether or not the read-compressed data is identical to the second writing data included in the first response data that is obtained by the first receiver 103.

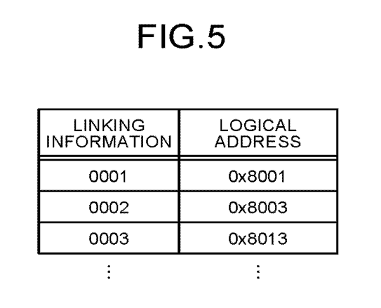

When it is determined that the first writing data is already stored, the determiner 110 does not instruct the data storage device 20 to write the second writing data. In the embodiment, when it is determined that the first writing data is already stored, the determiner 110 associates the address information corresponding to the first writing data (in this example, the logical addresses associated with the hash values of the first writing data) with the linking information included in the user data that is received by the user-data receiver 101 (the linking information linked to the first writing data, and updates second correspondence information that indicates the correspondence relationship between address information and linking information. FIG. 5 is a diagram illustrating an example of the second correspondence information. In this example, the second correspondence information indicates the correspondence relationship between the linking information, such as specific addresses or keys, and logical addresses. The linking information can be considered to represent information identifiers that are recognized by the user. The second correspondence information is stored in a second correspondence-information memory 111 illustrated in FIG. 2.

When the second writing data is not identical to the read-compressed data, the determiner 110 determines that the first writing data is not already stored. When it is determined that the first writing data is not already stored, the determiner 110 instructs the data storing device 20 to write the second writing data. In this example, when it is determined that the first writing data is not already stored, the determiner 110 sends writing request, which instructs the data storing device 20 to write the second writing data, to the data storing device 20.

Moreover, when it is determined that the first writing data is not already stored, the determiner 110 associates new address information (assigns new logical addresses) to the hash values of the first writing data so as to update the first correspondence information. In this example, the writing request at least includes the logical addresses that are newly assigned to the hash values of the first writing data which serves as the source of the second writing data to be written (i.e., can be considered as the logical addresses that are newly assigned to the second writing data to be written).

Furthermore, when it is determined that the first writing data is not already stored, the determiner 110 associates the address information, which is newly associated to the hash values of the first writing data, with the linking information included in the user data received by the user-data receiver 101 (i.e., the linking information linked to the first writing data), so as to update the second correspondence information.

Meanwhile, in the embodiment, before comparing the second writing data with the read-compressed data, the determiner 110 compares the size of the second writing data with the size of the read-compressed data. Only if the size of the second writing data is identical to the size of the read-compressed data, then the determiner 110 starts comparing the second writing data with the read-compressed data. However, if the size of the second writing data is not identical to the size of the read-compressed data, then the determiner 110 determines that the second writing data is not identical to the read-compressed data (i.e., determines that the first writing data serving as the source of the second writing data is not already stored).

In this example, the determiner 110 compares the size specified by second size information, which is included in the second response data obtained by the second receiver 108, with the size specified by first size information, which is included in the first response data obtained by the first receiver 103. When the two sizes are equal, the determiner 110 starts comparing the read-compared data included in the second response data with the second writing data included in the first response data, and determines whether or not the two pieces of data are identical. On the other hand, when the two sizes are not equal, the determiner 110 determines that the read-compared data included in the second response data is not identical to the second writing data included in the first response data. In this example, the functions of the determiner 110 are implemented by the data processor 11.

Given below is the explanation of the functions of the data storage device 20. As illustrated in FIG. 2, the data storage device includes a first interface 220, the compressor 202, the reading controller 205, and the writing controller 208.

The first interface 220 includes a first request receiver 201, a first sender 203, a second request receiver 204, a second sender 206, and a writing request receiver 207. In this example, the function of the first interface 220 is implemented by the host I/F 23 that can be configured using, for example, a serial ATA (SATA), a serial attached SCSI (SAS), or Ethernet. The first request receiver 201 obtains first requests from the host 10. Meanwhile, regarding the first sender 203, the second request receiver 204, the second sender 206, and the writing request receiver 207; the functions are described later.

The compressor 202 compresses the data input from the host 10. In the embodiment, when a first request is obtained by the first request receiver 201, the compressor 202 compresses the first writing data included in the first request according to the first request and generates second writing data. Then, the compressor 202 requests the first sender 203 to send the generated second writing data, and provides the generated second writing data to the writing controller 208.

The first sender 203 included in the first interface 220 sends the second writing data to the host 10 in response to a request from the compressor 202. That is, when the first writing data representing the target data for writing is input from the host 10; the first sender 203 sends, to the host 10, the second writing data obtained by the compressor 202 by compressing the first writing data. In the embodiment, the first sender 203 sends the second writing data and the first response data, which contains the first size information indicating the size of the second writing data, to the host 10. However, that is not the only possible case. Alternatively, for example, the first sender 203 may send, to the host 10, the first response data containing the second writing data but not containing the first size information which indicates the size of the second writing data.

The second request receiver 204 included in the first interface 220 obtains a second request from the host 10. Regarding the functions of the second sender 206 and the writing request receiver 207 included in the first interface 220, the explanation is given later.

When the second request receiver 204 obtains a second request, the reading controller 205 reads the compressed data, which is stored in the memory 21, in accordance with the second request. Herein, the memory 21 of the data storage device 20 includes a logical-physical conversion table 230 that indicates the correspondence relationship of the logical addresses with the physical addresses in the memory 21. However, the logical-physical conversion table 230 may be stored at any arbitrary destination such as in a memory other than the memory 21. For example, the logical-physical conversion table 230 may be stored in a dynamic random access memory (DRAM). The reading controller 205 reads the logical-physical conversion table 230 from the memory 21; refers to the logical-physical conversion table 230; and identities the physical addresses corresponding to the logical addresses included in the second request that is obtained by the second request receiver 204. Then, the reading controller 205 reads, as read-compressed data, the compressed data stored at the positions indicated by the identified physical addresses in the memory 21, and requests the first sender 203 to send the first sender 203.

The second sender 206 included in the first interface 220 sends the read-compressed data to the host 10 in response to a request from the reading controller 205. That is, when the address information (in this example, the logical addresses) corresponding to the first writing data are input from the host 10; the second sender 206 sends, to the host 10, the read-compressed data that represents the compressed data read from the memory 21 based on the address information. In essence, when the first writing data representing the target data for writing is input from the host 10; the first interface 220 (the first sender 203 and the second sender 206) according to the embodiment sends, to the host 10, the second writing data obtained by the compressor 202 by compressing the first writing data. Moreover, when the address information (in this example, the logical addresses) corresponding to the first writing data are input from the host 10; the first interface 220 (the first sender 203 and the second sender 206) according to the embodiment sends, to the host 10, the read-compressed data that represents the compressed data read front the memory 21 based on the address information.

In the embodiment, the second sender 206 sends, to the host 10, the second response data that contains the read-compressed data and the second size information indicating the size of the read-compressed data. However, that is not the only possible case. Alternatively, for example, the second sender 6 may send, to the host 10, the second response data containing the read-compressed data but not containing the second size information which indicates the size of the read-compressed data.

The writing request receiver 207 included in the first interface 220 obtains writing request from the host 10.

When the first interface 220 obtains the writing request, the writing controller 208 writes the second writing data in the memory 1 in accordance with the writing request. More particularly, the writing controller 208 writes the second writing data, which is provided by the compressor 202, in the free space of the memory. Then, the writing controller 208 associates the physics addresses, which indicate the positions in the memory 21 at which the second writing data is written, with the logical addresses included in the writing request, so as to update the logical-physical conversion table 230.

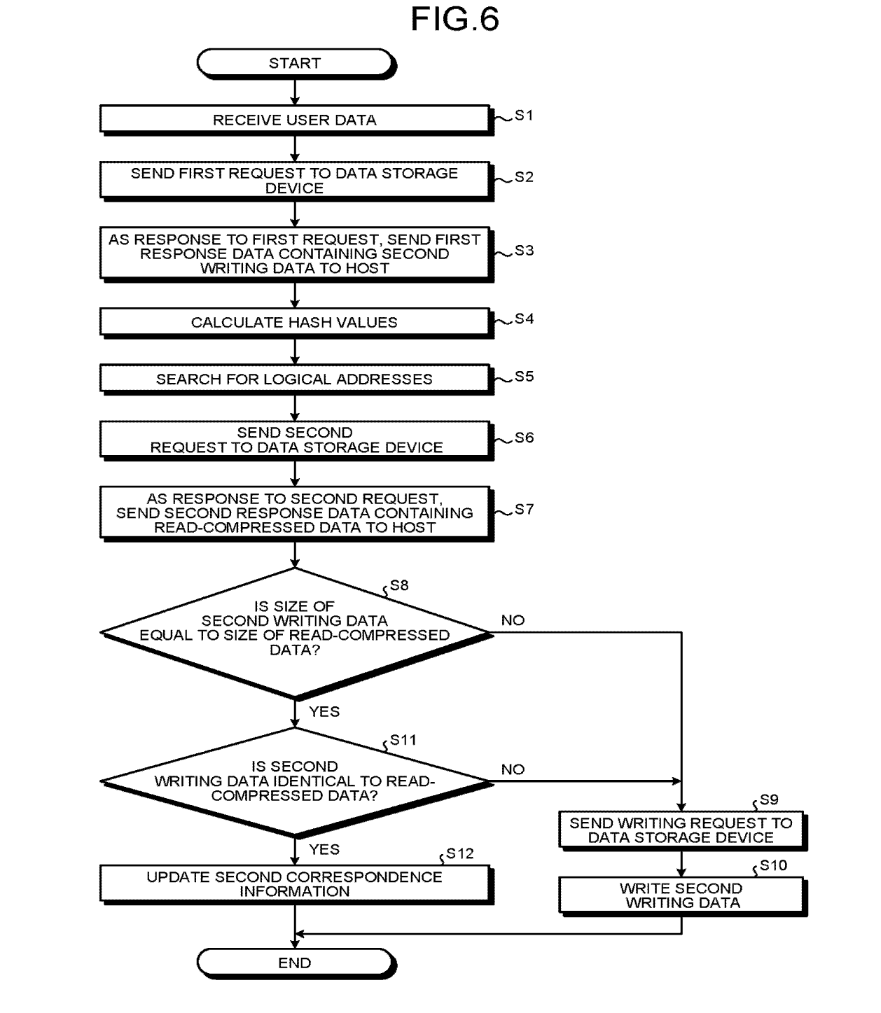

FIG. 6 is a flowchart for explaining an example of operations performed in the data storage system 1 according to the embodiment. Firstly, the host 10 (the user-data receiver 101) receives input of the user data (Step S1). Then, the host 10 (the third sender 102) sends, to the data storage device 20, a first request for compression of the first writing data included in the user data that is received at Step S1 (Step S2). In response to the first request received from the host 10, the data storage device (the compressor 202) compresses the first writing data included in the first request and generates second writing data. Then, the data storage device 20 (the first sender 203) sends, as a response with respect to the first request, first response data, which contains the generated second writing data and first size information indicating the size of the second writing data, to the host 10 (Step S3). The specific contents of the operation at each of these steps are as described previously.

Moreover, the host 10 (the calculator 104) calculates the hash values of the first writing data included in the user data that is received at Step S1 (Step S4). Then, the host 10 (the searcher 105) refers to the first correspondence information and searches for the logical addresses associated to the hash values calculated at Step S4 (Step 55). Subsequently, the host 10 (the fourth sender 107) sends, to the data storage device 20, a second request for reading data based on the logical addresses retrieved at Step S5 (Step S6). In response to the second request received from the host 10, the data storage device 20 (the reading controller 205) reads the compressed data from the memory 21. Then, the data storage device 20 (the second sender 206) sends, to the host 10, second response data that contains read-compressed data indicating the compressed data that is read and second size information indicating the size of the read-compressed data (Step S7). The specific contents of the operation at each of these steps are as described previously.

Subsequently, the host 10 (the determiner 110) compares the size specified in the first size information, which is included in the first response data brained from the data storage device 20, with the size specified in the second size information, which is included in the second response data obtained from the data storage device 20; and determines whether or not the size of the second writing data is identical to the size of the read-compressed data (Step S8).

If the two sizes are not equal (No Step S8), then the host 10 determines that the first writing data, which is included in the user data received at Step S1, not already stored and sends, to the data storage device 20, writing request for instructing the data storage device 20 to write the second writing data (Step S9). Moreover, as described previously, the host 10 (the determiner 110) updates the first correspondence information and the second correspondence information. The data storage device 20 (the writing controller 208) writes the second writing data in the memory 21 according to the writing request (Step S10). The specific contents of the operation at each of these steps are as described previously.

If the two sizes are equal (Yes at Step S8, then the host 10 (the determiner 110) compares the second writing data, which is included in the first response data obtained from the data storage device 20, with the read-compressed data, which is included in the second response data obtained from the data storage device 20; and determines whether the two pieces of data are identical (Step S11). If the two pieces of data are not identical (No at Step S11), then then the system control returns to Step S9. On the other hand, if the two pieces of data are identical (Yes at Step S11), then the host 10 (the determiner 110) determines that the first writing data, which is included in the user data received at Step S1, is already stored and updates the second correspondence information without instructing the data storage device 20 to write the second writing data (Step S12). The specific contents of the operation at each of these steps are as described previously.

As descried above, in the data storage system 1 according to the embodiment, when the first writing data representing the target data for writing is input from the host 10; the data storage device 20 sends the second writing data, which is obtained by the compressor 202 by compressing the first writing data, to the host 10. Moreover, when the address information corresponding to the first writing data is input from the host 10, the data storage device 20 sends the read-compressed data, which indicates the compressed data read from the memory 21 based on the address information, to the host 10. If the second writing data is identical to the read-compressed data, then the host 10 determines that the first writing data representing the target data for writing is already stored (represents duplicate data). Thus, duplication determination is performed by comparing the pieces of compressed data. With that, the degree of accuracy of duplication determination can be guaranteed with only a small amount of calculations.

The data storage device 20 may be configured t have the function of comparing the second writing data and the read-compressed data, and sending the comparison result to the host 10.

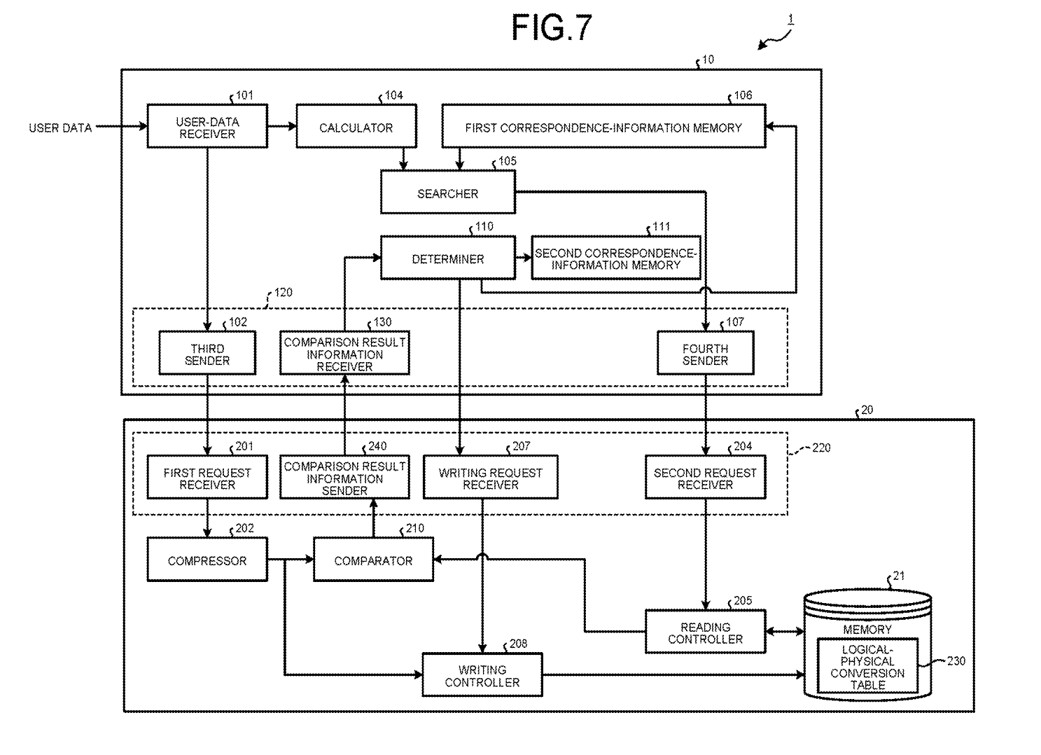

FIG. 7 a diagram illustrating an example of the functions of the data storage system according to a modification example. As illustrated in FIG. 7, the difference with the embodiment are as follows: the data storage device 20 includes a comparator 210; the first interface 220 includes a comparison result information sender 240 in place of the first sender 203 and the second sender 206; and the second interface 120 of the host 10 includes a comparison result information receiver 130 in place of the first receiver 103 and the second receiver 108. The comparator 210 compares the first writing data, which is input from the host 10, with the second writing data, which is obtained by the compressor 202 by performing compression, and with the read-compressed data, which represents the compressed data that is read from the memory 21 based on the address information corresponding to the first writing data. Thus, the comparator 210 compares the second writing data, which is generated by the compressor 202 generated according to a first request, with the read-compressed data, which is read by the reading controller 205 according to a second request. The comparison result information sender 240 included in the first interface 220 sends comparison result information, which indicates the result of comparison performed by the comparator 210, to the host 10.

The comparison result information receiver 130 included in the second interface 120 of the host 10 obtains the comparison result information. If the comparison result information obtained by the comparison result information receiver 130 indicates that the second writing data is identical to the read-compressed data, then the determiner 110 of the host 10 determines that the first writing data already stored. Meanwhile, the remaining configuration is identical to tie first embodiment. Hence, the detailed explanation is not repeated.

In the modification example, the determiner 110 of the host 10 can determine whether or not the first writing data is already stored (can perform duplication determination) by using the comparison result information received from the comparator 210. Thus, while performing duplication determination, the determiner 110 need not receive the second writing data or the read-compressed data from the data storage device 20. Hence, as compared to the embodiment, the volume of communication through the storage I/F can be reduced.

As another modification example, two or more data rage device 20 can be connected to the host 10, and the data storage device 2 to be used for writing can be different from the data storage device 20 to be used for reading. Meanwhile, the embodiment and the modification examples can be combined in an arbitrary manner.

While a certain embodiment has been described, the embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended cover such forms or modifications as would fall within the scope and spirit of the inventions.

What is claimed is:

1. A data storage system comprising:
a host computer that performs input and output of data; and
a data storage device that is connected to the host computer, wherein
the data storage device includes
a compressor configured to compress data input from the host computer,
a memory configured to store data compressed by the compressor, and
a first interface configured to
when first writing data is input from the host computer, send second writing data, which is obtained by the compressor by compressing the first writing data, to the host computer, and
when address information corresponding to the first writing data is input from the host computer, send read-compressed data, which represents the compressed data read from the memory based on the address information, to the host computer, and
the host computer includes a determiner configured to, when the second writing data is identical to the read-compressed data, determine that the first writing data is already stored.

2. The system according to claim 1, wherein
when the second writing data is not identical to the read-compressed data, the determiner determines that the first writing data is not already stored,
when it is determined that the first writing data is already stored, the determiner does not instruct the data storage device to write the second writing data in, and
when it is determined that the first writing data is not already stored, the determiner instructs the data storage device to write the second writing data.

3. The system according to claim 1, wherein
the determiner compares size of the second writing data with size of the read-compressed data before comparing the second writing data with the read-compressed data,
when the size of the second writing data is identical to the size of the read-compressed data, the determiner starts comparing the second writing data with the read-compressed data, and
when the size of the second writing data is not identical to the size of the read-compressed data, the determiner determines that the second writing data is not identical to the read-compressed data.

4. The system according to claim 1, wherein the host computer includes
a calculator configured to calculate a hash value of the first writing data,
a searcher configured to refer to first correspondence information in which hash values and pieces of the address information are associated, and search for the address information associated with the hash value calculated by the calculator, and
a second interface configured to send the first writing data to the data storage device, and send the address information retrieved by the searcher as the address information corresponding to the first writing data to the data storage device.

5. The system according to claim 4, wherein the calculator calculates a hash value for each of a plurality of pieces of unit data obtained by dividing the first writing data,
the searcher searches for the address information for each of a plurality of hash values calculated by the calculator and having a one-to-one correspondence with the plurality pieces of unit data, and
the second interface sends, to the data storage device, a plurality of piece of the address information retrieved by the searcher and having a one-to-one correspondence with the plurality of hash values.

6. The system according to claim 4, wherein
the host computer further includes a receiver configured to receive input of user data which contains the first writing data, linking information to which the first writing data is linked, and information instructing writing of the first writing data,
the second interface
sends the first writing data, which is contained in the user data received by the receiver, to the data storage device, and
sends the address information associated with the hash value of the first writing data, which is contained in the user data received by the receiver, as the address information corresponding to the first writing data to the data storage device.

7. The system according to claim 6, wherein, when it is determined that the first writing data contained in the user data received by the receiver is already stored, the determiner associates the address information corresponding to the first writing data with the linking information contained in the user data received by the receiver, so as to update second correspondence information indicating correspondence relationship between the address information and the linking information.

8. The system according to claim 6, wherein, when it is determined that the first writing data contained in the user data received by the receiver is not already stored, the determiner associates new address information with the hash value of the first writing data, so as to update the first correspondence information.

9. The system according to claim 8, wherein, when it determined that the first writing data contained in the user data received by the receiver is not already stored, toe determiner associates the address information, which is newly associated with the hash value of the first writing data, with the linking information contained in the user data received by the receiver, so as to update second correspondence information indicating correspondence relationship between the address information and the linking information.

10. The system according to 1, wherein the address information is information indicating a logical address.

11. A data storage system comprising:
a host computer that performs input and output of data; and
a data storage device that is connected to the computer, wherein
the data storage device includes
a compressor configured to compress data input from the host computer,
a memory configured to store therein compressed data representing data compressed by the compressor,
a comparator configured to compare the first writing data, which is input from the host computer, with second writing data, which is obtained by the compressor by performing compression, and with read-compressed data, which indicates the compressed data read from the memory based on address information corresponding to the first writing data, and
a first interface configured to send comparison result information, which indicates result of comparison performed by the comparator, to the host computer, and
the host computer includes a determiner configured to, when the comparison result information indicates that the second writing data is identical to the read-compressed data, determine that the first writing data is already stored.

12. A data storage device that is connected to a host computer which performs input and output of data and which determines whether first writing data is already stored, the data storage device comprising:
a compressor configured to compress data input from the host computer;
a memory configured to store therein compressed data representing data compressed by the compressor; and
a first interface configured to
when the first writing data is input from the host computer, send second writing data, which is obtained by the compressor by compressing the first writing data, to the host computer, and
when address information corresponding to the first writing data is input from the host computer, send read-compressed data, which represents the compressed data read from the memory based on the address information, to the host computer.

13. A data storage device that is connected to a host computer which performs input and output of data and which determines whether or not first writing data is already stored, the data storage device comprising:
a compressor configured to compress data input from the host computer;
a memory configured to store therein compressed data representing data compressed by the compressor;
a comparator configured to compare the first writing data, which is input from the host computer, with second writing data, which is obtained by the compressor by performing compression, and with read-compressed data, which indicates the compressed data read from the memory based on address information corresponding to the first writing data; and
a first interface configured to send comparison result information, which indicates result of comparison performed by the comparator, to the host computer.
